(19) United States
(12) Patent Application Publication
(10) Pub. No.: US 2007/0276075 A1
(43) Pub. Date: Nov. 29, 2007

(54) Process for Producing Polyorganosiloxane-Containing Resin and Resin Composition Containing the Resin

(75) Inventors: Akira Takaki, Hyogo (JP); Takao Michinobu, Osaka (JP)

Correspondence Address: BRINKS HOFER GILSON & LIONE, P.O. BOX 10395, CHICAGO, IL, 60610, US

(73) Assignee: KANEKA CORPORATION, Osaka (JP)

(21) Appl. No.: 10/592,015

(22) PCT Filed: Mar. 11, 2005
(86) PCT No.: PCT/JP05/04290

§ 371 Date: Jul. 23, 2007

(30) Foreign Application Priority Data
Mar. 15, 2004 (JP) 2004-073564

(51) Int. Cl. C08J 3/16; C08G 77/20

(52) U.S. Cl. 524/439; 525/474; 528/10

(57) ABSTRACT

The present invention provides a polyorganosiloxane-containing resin decreased in volatile siloxane content. A resin which contains 5% or more of volatile silicon compounds immediately after coagulation and dehydration is mixed with an organic solvent, and the resultant mixture is filtered to decrease the content of the volatile silicon compounds in the resin. Therefore, the target polyorganosiloxane-containing resin decreased in volatile siloxane content can be obtained. Mixing the polyorganosiloxane-containing resin and a thermoplastic resin and/or a thermosetting resin gives a resin composition having improved strength.

### TECHNICAL FIELD

The present invention relates to a process for producing a polyorganosiloxane-containing resin, a polyorganosiloxane-containing resin produced by the process, and a resin composition containing the polyorganosiloxane-containing resin.

### BACKGROUND ART

Silicone has peculiar properties such as heat resistance, cold resistance, a mold release property, water repellency, etc. These peculiar properties create various high-added value commodities such as lubricants, impact modifiers, release agents, and the like.

A generally known process for producing a polyorganosiloxane emulsion is emulsion polymerization of a cyclic siloxane or alkoxy silane under acidic or basic conditions (Patent Document 1, etc.). Since this reaction is an equilibrium reaction between polycondensation for forming a siloxane bond (Si—O—Si) from silanol (Si—OH) and hydrolytic depolymerization, a low-molecular-weight volatile siloxane is produced at the end of polymerization, i.e., at the time when equilibrium is attained, particularly in the presence of an aqueous medium. The content of the volatile siloxane is not significantly decreased even by further polymerization of a vinyl monomer. The volatile siloxane is removed from an emulsion or the like by, for example, salt coagulation, dehydration, and drying, solvent coagulation, filtration, and drying, or spray drying of polyorganosiloxane or a resin containing it, and released as exhaust gas to the air. This causes the large problems of useless consumption of raw materials and atmospheric pollution. In this background, many techniques for producing emulsions decreased in volatile siloxane content have been investigated.

A process for producing an emulsion is easily conceived, in which silicone oil or a siloxane oligomer is used as a starting material, and a low-molecular-weight siloxane is removed by solvent extraction (Patent Document 2), vacuum heating (Patent Document 3), or subcritial or supercritical carbon dioxide extraction (Patent Document 4), followed by forced fine dispersion to produce emulsion in an aqueous medium by a mechanical method under high pressure and shear. Another known process further includes condensation reaction and then neutralization to terminate polymerization/depolymerization (Patent Document 5). The polyorganosiloxane emulsions produced by these processes contain small amounts of low-molecular-weight volatile siloxane, but there may be the problem of separating polyorganosiloxane from the aqueous medium in long-term storage because of the low stability of the emulsions. Furthermore, the resulting emulsions have a wide particle diameter distribution, and thus subsequent graft-modification reaction cannot be homogeneously performed for producing polyorganosiloxane-containing resins. Therefore, improvement may be required.

In a process for producing a polyorganosiloxane emulsion without the deterioration of stability even in long-term storage and the separation of an oil component, i.e., a process of emulsion polymerization of cyclic organosiloxane in the presence of a nonionic surfactant, an ionic surfactant, or a polymerization catalyst, the content of volatile siloxane is decreased in an example (Patent Document 6). However, the reason for this is not known, and a control method is not disclosed. In addition, it is disclosed that the content of volatile siloxane is not always decreased. In a process of combining a tri- or higher functional silane while controlling a gel fraction, such an example is disclosed (Patent Document 7). This is supposed to be due to the fact that the probability of production of volatile siloxane is decreased by introducing a crosslinked structure into a siloxane skeleton. Although the gel fraction of the resultant polyorganosiloxane is controlled, the finally resulting polyorganosiloxane-containing resin or a composition thereof is fragile, and sufficient mechanical strength is not exhibited in some cases.

As another process for producing an emulsion decreased in volatile siloxane content, a heat stripping process is disclosed (Patent Document 8). However, this process still has the problem of requiring huge equipment and an enormous amount of energy for industrial production.

Furthermore, there is disclosed a process for decreasing the content of volatile siloxane in which diatomite is added to a latex of polyorganosiloxane, and the resultant mixture is stirred to adsorb a low-molecular-weight siloxane on the diatom earth and then filtered to remove the siloxane (Patent Document 9). This process requires a treatment method to be secured for treating the diatom earth on which the low-molecular-weight siloxane has been adsorbed.

All the techniques of Patent Documents 2 to 9 have the effect of decreasing the content of volatile low-molecular-weight siloxane but have respective problems. Therefore, a more simple and effective process is required.

Patent Document 1: U.S. Pat. No. 2,891,920

Patent Document 2: Japanese Unexamined Patent Application Publication No. 07-330905

Patent Document 3: Japanese Unexamined Patent Application Publication No. 07-278473

Patent Document 4: Japanese Unexamined Patent Application Publication No. 06-107796

Patent Document 5: Japanese Unexamined Patent Application Publication No. 2001-288269

Patent Document 6: EP Patent No. 459500

Patent Document 7: U.S. Pat. No. 5,661,215

Patent Document 8: U.S. Pat. No. 4,600,436

Patent Document 9: Japanese Unexamined Patent Application Publication No. 2002-121284

### DISCLOSURE OF THE INVENTION

Problem to be Solved by the Invention

An object of the present invention is to provide a novel process for producing a polyorganosiloxane-containing resin having a decreased content of volatile low-molecular-weight siloxane, a polyorganosiloxane-containing resin produced by the process, and a resin composition containing the polyorganosiloxane-containing resin.

Means for Solving the Problem

As a result of intensive research on the above-descried object, the inventors have achieved the present invention in which a polyorganosiloxane-containing resin after coagulation and dehydration is mixed with an organic solvent, and the resultant mixture is filtered to decrease a residue such as a volatile siloxane in the resin.

In other words, the present invention relates to a process for producing a polyorganosiloxane-containing resin in which a polyorganosiloxane-containing resin containing 5% by weight or more of a volatile siloxane immediately after coagulation and dehydration is mixed with an organic solvent, and the resultant mixture is filtered to decrease a residue in the resin.

In a preferred embodiment, the present invention relates to the process for producing the polyorganosiloxane-containing resin in which the residue is a volatile siloxane.

In a preferred embodiment, the present invention relates to the process for producing the polyorganosiloxane-containing resin in which the organic solvent is an alcohol.

In a preferred embodiment, the present invention relates to the process for producing the polyorganosiloxane-containing resin in which a polyorganosiloxane-containing resin after coagulation and dehydration is mixed with an organic solvent only once, and the resultant mixture is filtered.

In a preferred embodiment, the present invention relates to the process for producing the polyorganosiloxane-containing resin in which the Calcium (Ca) content of the resin is 300 to 1000 ppm.

The present invention also relates to a polyorganosiloxane-containing resin produced by the above-descried process.

The present invention further relates to a resin composition containing a thermoplastic resin and/or a thermosetting resin and the polyorganosiloxane-containing resin described above.

Effect of the Invention

A polyorganosiloxane-containing resin after coagulation and dehydration is mixed with an organic solvent, preferably methanol, and the resultant mixture is filtered to decrease the content of residual volatile siloxane in the resin. A molded product of a resin composition of the resin with a polycarbonate exhibits excellent flame retardancy and impact resistance.

### BEST MODE FOR CARRYING OUT THE INVENTION

The present invention provides a process for producing a polyorganosiloxane-containing resin in which a polyorganosiloxane-containing resin containing 5% by weight or more of volatile siloxane immediately after coagulation and dehydration is mixed with an organic solvent, and the resultant mixture is filtered to decrease a residue such as a volatile siloxane in the resin.

The polyorganosiloxane-containing resin used in the present invention is preferably prepared by polymerization of a vinyl monomer, and specifically contains 5% by weight or more of volatile siloxane immediately after coagulation and dehydration. Therefore, the present invention can be applied to a polyorganosiloxane-containing resin having a high content of polyorganosiloxane. However, the present invention cannot be applied to acryl-silicone composite rubber having a low content of polyorganosiloxane.

The polyorganosiloxane used in the present invention can be prepared by usual emulsion polymerization, but seed polymerization may be used because of the advantage that the particle diameter distribution of the latex can be narrowed. Examples of a seed polymer used in seed polymerization include rubber components such as butyl acrylate rubber, butadiene rubber, butadiene-styrene rubber, and butadiene-acrylonitrile rubber. However, the seed polymer is not limited to these examples, and copolymers such as a butyl acrylate-styrene copolymer and a styrene-acrylonitrile copolymer may be used. Also, a chain transfer agent may be used in polymerization for the seed polymer.

In polymerization for the polyorganosiloxane used in the present invention, a grafting agent, and if required, a crosslinking agent may be used.

The organosiloxane used has a structural unit represented by the general formula RₘSiO_{(4-m)/2} (wherein R represents a substituted or unsubstituted monovalent hydrocarbon group, and m represents an integer of 0 to 3) and has a linear, branched, or cyclic structure, and preferably a cyclic structure. Examples of a substituted or unsubstituted monovalent hydrocarbon group in the organosiloxane include a methyl group, an ethyl group, a propyl group, a phenyl group, and these hydrocarbon groups substituted by a cyano group or the like. Examples of the organosiloxane include cyclic compounds, such as
hexamethylcyclotrisiloxane (D3),
octamethylcyclotetrasiloxane (D4),
decamethylcyclopentasiloxane (D5),
dodecamethylcyclohexasiloxane (D6), and
trimethyltriphenylcyclotrisiloxane; and linear or branched organosiloxane compounds. These organosiloxane compounds can be used alone or in combination of two or more.

Examples of the grafting agent that can be used in the present invention include p-vinylphenylmethyl dimethoxysilane, p-vinylphenylethyl dimethoxysilane, 2-(p-vinylphenyl)ethylmethyl dimethoxysilane, 3-(p-vinylbenzoyloxy)propylmethyl dimethoxysilane, p-vinylphenylmethyl dimethoxysilane, vinylmethyl dimethoxysilane, tetravinyltetramethyl cyclosiloxane, allylmethyl dimethoxysilane, mercaptopropylmethyl dimethoxysilane, and methacryloxypropylmethyl dimethoxysilane.

The ratio of the grafting agent used is preferably 0.1 to 5% by weight relative to the organosiloxane. When the amount of the grafting agent used is excessively large, the impact resistance of the final molded product is decreased, while when the amount of the grafting agent used is excessively small, large lumps occur in coagulation and heat treatment, resulting in the tendency that a normal resin powder cannot be obtained or the moldability of the final molded product is decreased.

In synthesizing the polyorganosiloxane used in the present invention, if required, the crosslinking agent may be added. Examples of the crosslinking agent include trifunctional crosslinking agents, such as methyl trimethoxysilane, phenyl trimethoxysilane, and ethyl triethoxysialne; and tetrafunctional crosslinking agents, such as tetraethoxysilane, 1,3-bis[2-(dimethoxymethylsilyl)ethyl]benzene, 1,4-bis[2-(dimethoxymethylsilyl)ethyl]benzene, 1,3-bis[1-(dimethoxymethylsilyl)ethyl]benzene, 1,4-bis[1-(dimethoxymethylsilyl)ethyl]benzene, 1-[1-(dimethoxymethylsilyl)ethyl]-3-[2-(dimethoxymethylsilyl)ethyl)]benzene, and 1-[1-(dimethoxymethylsilyl)ethyl]-4-[2-dimethoxymethylsily)ethyl]benzene. These crosslinking agents can be used alone or in combination of two or more. When the amount of the crosslinking agent added is excessively large, the flexibility of the polyorganosiloxane is degraded, thereby decreasing the impact resistance of the final molded product.

The average particle diameter of the polyorganosiloxane in a latex state is preferably 0.008 to 0.6 μm and more preferably 0.08 to 0.4 μm. It is difficult to stably obtain the polyorganosiloxane having an average particle diameter of less than 0.008 μm, and the polyorganosiloxane having an average particle diameter over 0.6 μm may impair the impact resistance of the final molded product.

The vinyl monomer used in the present invention is the component for securing compatibility with the thermoplastic resin mixed with the polyorganosiloxane-containing resin and uniformly dispersing the polyorganosiloxane-containing resin therein. Examples of the vinyl monomer include, depending on the thermoplastic resin mixed, aromatic vinyl monomers, such as styrene and α-methylstyrene; vinyl cyanide monomers, such as acrylonitrile; (meth)acrylate monomers, such as methyl acrylate, ethyl acrylate, methyl methacrylate, ethyl methacrylate, and butyl methacrylate; and vinyl monomers each having an epoxy group in its molecule, such as glycidyl methacrylate. These compounds may be used alone or in combination of two or more.

Examples of a radical initiator for polymerization of the vinyl monomer in the present invention include organic peroxides, such as cumen hydroperoxide, tert-butyl hydroperoxide, benzoyl peroxide, and tert-butyl peroxyisopropylcarbonate; inorganic peroxides, such as potassium persulfate and ammonium persulfate; azo compounds, such as 2,2′-azobisisobutyronitrile and 2,2′-azobis-2,4-dimethylvaleronitrile. The polymerization can be completed at a low polymerization temperature in a redox system of ferrous sulfate-sodium formaldehyde sulfoxylate-ethylenediamine tetraacetic acid disodium salt, ferrous sulfate-glucose-sodium pyrophosphate, or ferrous sulfate-sodium pyrophosphate-sodium phosphate.

The polyorganosiloxane-containing resin prepared by emulsion polymerization is coagulated and granulated by adding a metal salt such as calcium chloride, magnesium chloride, or magnesium sulfate or adding a large amount of an organic solvent such as methanol, ethanol, or propanol. If required, the coagulated and granulated resin is heat-treated and then dehydrated with a centrifugal dehydrator.

In washing with an organic solvent, for example, the dehydrated polyorganosiloxane-containing graft polymer is mixed with an organic solvent which dissolves the emulsifier used in the polymerization or a salt thereof, followed by stirring and filtration. Washing the graft polymer before drying is preferred because the residual monomers, the emulsifier, and the salt thereof can be efficiently removed.

It is preferred that the polyorganosiloxane-containing resin containing 5% by weight or more of volatile siloxane immediately after dehydration is mixed with an organic solvent which dissolves the volatile siloxane, and the resultant mixture is stirred and then filtered. The technique of washing a resin with an organic solvent has been used for a long time. For example, Japanese Unexamined Patent Application Publication No. 2002-105122 shows a method for carefully washing a graft copolymer resin product powder with ion-exchanged water or alcohol at 40° C. or more to decrease the Calcium ion content and Sodium (Na) ion content to 200 ppm or less and 3 ppm or less, respectively, the resin product powder being used for an image-forming member such as an electrophotographic photosensitive member, or an electrophotographic apparatus including the image forming member in which it becomes important to remove metal ions. Since the present invention is aimed at decreasing the volatile siloxane content in the polyorganosiloxane-containing resin containing 5% by weight or more of volatile siloxane immediately after dehydration, the present invention is not applied to acryl-silicone composite rubber which is a preferable target resin in Japanese Unexamined Patent Application Publication No. 2002-105122.

In the present invention, mixing and stirring are repeated several times according to demand. The resin after filtration is dried to produce a powdery resin. Furthermore, the filtrate after filtration contains water, methanol, and volatile siloxane, but these components can be recycled by fractional distillation.

The organic solvent used in the present invention preferably dissolves the volatile siloxane, but not the polyorganosiloxane-containing resin. In view of cost, an alcohol having 1 to 3 carbon atoms is preferred. Specifically, methanol, ethanol, and propanol are preferred, and methanol and ethanol are more preferred.

The amount of the volatile siloxane remaining in the resin decreases as the amount of the organic solvent used in the present invention increases. However, the optimum amount of the organic solvent is determined in view of economical standpoint and so forth.

In the present invention, the amount of the volatile siloxane remaining in the resin tends to decrease as the organic solvent washing temperature increases.

In the present invention, the amount of the volatile siloxane remaining in the resin tends to decrease as the number of times of organic solvent washing increases. However, even if the number of times of washing is increased, the flame retardancy of a polyorganosiloxane-containing flame retardant is not changed. On the other hand, the process is lengthened to increase the production equipment cost as the number of times of washing increases. Therefore, it is preferred to perform one time of washing by increasing the washing temperature or the amount of the organic solvent used. The washing method, number of times, and conditions may be appropriately selected so that the Calcium content of a polyorganosiloxane-containing graft polymer is in the range exemplified below. However, in view of cost of production equipment, the Calcium content is preferably 300 to 1000 ppm. Under conditions in which the Calcium content exceeds 1000 ppm, the volatile siloxane content does not reach the intended level. Under conditions in which the Calcium content is less than 300 ppm, the flame retardancy and impact resistance of the final molded product are little improved, and the cost efficiency of production equipment is decreased.

Mixing the resultant polyorganosiloxane-containing resin with any one of various thermoplastic resins gives a resin composition having excellent flame retardancy and impact resistance, and the like.

Usable examples of the thermoplastic resins include polycarbonate; polycarbonate/polyester mixed resins such as polycarbonate/polyethylene terephthalate mixed resins and polycarbonate/polybutylene terephthalate mixed resins; polycarbonate/acrylonitrile-styrene copolymer mixed resins; polycarbonate/butadiene-styrene copolymer (HIPS resin) mixed resins; polycarbonate/acrylonitrile-butadiene rubber-styrene copolymer (ABS resin) mixed resins; polycarbonate/ acrylonitrile-butadiene rubber-α-methylstyrene copolymer mixed resins; polycarbonate/styrene-butadiene rubber-acrylonitrile-N-phenylmaleimide copolymer mixed resins; and polycarbonate/acrylonitrile-acrylic rubber-styrene copolymer (AAS resin) mixed resins.

The amount of the polyorganosiloxane-containing resin added to the thermoplastic resin is preferably 0.1 to 20 parts by weight relative to 100 parts by weight of the thermoplastic resin. With the amount less than 0.1 parts by weight, the flame retardancy and impact resistance of the final molded product are not improved in some cases. On the other hand, with the amount exceeding 20 parts by weight, the moldability (flowability) of the molded product is significantly decreased in some cases.

The polyorganosiloxane-containing resin powder can be mixed with the thermoplastic resin using a Henschel mixer, a ribbon blender, or the like, followed by roll-kneader, an extruder, a kneader, or the like.

In this mixing, commonly used additives, such as an antioxidant, an anti-dropping agent, a polymeric processing aid, a flame retardant, an impact resistance modifier, a plasticizer, a lubricant, an ultraviolet absorber, a pigment, a glass fiber, a filler, a polymeric lubricant, and the like, may be added.

As a method for molding the resin composition, a molding method generally used for molding thermoplastic resin compositions, i.e., injection molding, extrusion molding, blow molding, calender molding, or the like, can be used.

The resultant molded product is excellent in flame retardancy and impact resistance.

### EXAMPLES

Although the present invention will be described in detail with reference to examples, the present invention is not limited to these examples. In the examples and comparative examples, measurements and tests were performed as follows:

[Polymerization Conversion Rate]

A latex was dried with a hot-air dryer at 120° C. for 1 hour to determine the solid content, and a polymerization conversion rate was calculated by 100×solid content/amount of monomers charged (%).

[Volume-Average Particle Diameter]

The volume-average particle diameters of a seed polymer, polyorganosiloxane particles, and a graft copolymer were measured in a latex state. The volume-average particle diameter (μm) was measured by a light scattering method using measuring device, MICROTRAC UPA, manufactured by LEED & NORTHRUP INSTRUMENTS.

[Volatile Siloxane Content]

The volatile siloxane content was determined by gas chromatographic (GC) analysis. Methyl ethyl ketone was added to a latex or a dehydrated resin or powder to perform extraction, and octamethyl trisiloxane was added as an internal standard. In the analysis, gas chromatograph GC-14B (manufactured by Shimadzu Corporation) using column Silicone DC-550 of 3 mm in diameter×3 m packed with 20 wt %. Chromosorb WNAW#60-80 was used.
Octamethyltetracyclosiloxane (D4),
decamethylcyclopentasiloxane (D5), and
dodecamethylcyclohexasiloxane (D6) were measured by the analysis to determine the volatile siloxane content from the ratio of the total content of these compounds to the resin solid content.
   [Measurement of Calcium Content]

Three grams of the resin was quantitatively analyzed in a helium atmosphere using SPECTORO energy-dispersive fluorescence X-ray analyzer XEPOS manufactured by Rigaku Industrial Corporation.

[Impact Resistance]

According to ASTM D-256, the impact resistance was measured by an Izod test at −10° C. using a notched ⅛-inch bar.

[Flame Retardancy]

The flame retardancy was measured by the UL94 V test using a 1/16-inch test specimen (1.5 mm in thickness).

### Examples 1 to 5

A mixture containing 300 parts by weight of pure water, 0.5 parts by weight (solid content) of SDBS, 95 parts by weight of octamethylcyclotetrasiloxane, and 5 parts by weight of mercaptopropyl dimethoxymethylsilane (MPDS) was stirred with a homomixer at 7,000 rpm for 5 minutes to prepare an emulsion. The resultant emulsion was added at a time into a five-necked flask provided with a stirrer, a reflux condenser, a nitrogen blowing inlet, a monomer addition inlet, and a thermometer.

Next, 1 part by weight (solid content) of a 10% aqueous solution of dodecylbenzenesulfonic acid was added to the flask, and the temperature was increased to 80° C. under stirring in a nitrogen stream. After stirring at 80° C. for 6 hours, the mixture was cooled to 25° C. and allowed to stand for 20 hours. Then, the pH was controlled to 6.5 with sodium hydroxide to terminate polymerization. As a result, a polyorganosiloxane latex was obtained.

Next, in a five-necked flask provided with a stirrer, a reflux condenser, a nitrogen blowing inlet, a monomer addition inlet, and a thermometer, 240 parts by weight of pure water and 70 parts by weight (solid content) of the polyorganosiloxane were charged, and the temperature was increased to 40° C. under stirring in a nitrogen stream. After the temperature reached 40° C., 0.2 parts by weight of sodium formaldehyde sulfoxylate (SFS), 0.01 parts by weight of disodium ethylenediamine tetraacetate (EDTA), and 0.0025 parts by weight of ferrous sulfate were added to the mixture, and then a mixture containing 3 parts by weight of allyl methacrylate (ALMA) and 0.01 parts by weight (solid content) of cumen hydroperoxide was added at a time to the resultant mixture, followed by stirring at 40° C. for 1 hour. Then, a mixture containing 30 parts by weight of methyl methacrylate (MMA) and 0.06 parts by weight (solid content) of cumen hydroperoxide was added dropwise over 1.5 hours. After the addition, stirring was continued for 1 hour to obtain a graft copolymer latex.

Next, the latex was diluted with pure water to a solid content of 15%, and 4 parts by weight (solid content) of a 25% aqueous solution of calcium chloride was added to prepare coagulated slurry. The coagulated slurry was heated to 95° C., cooled to 50° C., and the dehydrated (solid content of 70% by weight), and then the residual volatile siloxane content was measured. Next, 100 g (solid content) of the dehydrated polyorganosiloxane-containing resin was placed in a 2000 cc beaker. The resin was washed with methanol using a stirrer for 30 minutes with the methanol amount, washing temperature, and number of washing times shown in Table 1, followed by filtration. The residual volatile siloxane content in the polyorganosiloxane-containing resin was again measured. The results are shown in Table 1. The volatile siloxane was completely removed from the resin using a dryer to produce a powder.

Next, 100 parts by weight of polycarbonate resin (TARFLON FN1900A manufactured by Idemitsu Petrochemical Co., Ltd.) and the polyorganosiloxane-containing resin powder were mixed to prepare each of the compositions shown in Table 1. Furthermore, a mixture containing 0.5 parts by weight of an anti-dropping agent, polytetrafluoroethylene (POLYFLON FA-500 manufactured by Daikin Industries Ltd.), 0.3 parts by weight of a phosphate antioxidant (ADEKASTAB PEP36 manufactured by Adenka Corp.) serving as a stabilizer, and 0.3 parts by weight of a phenolic stabilizer (TOPANOL CA manufactured by ICI Japan Ltd.) was added to each composition.

Each of the resultant compositions was melt-kneaded with a twin-screw extruder (TEX44SS manufactured by Japan Steel Works, Ltd.) at 270° C. and then pelletized. The resultant pellets were formed into a ⅛-inch impact test specimen and a 1/16-inch flame retardancy test specimen using injection molding machine FAS100B manufactured by FANUC Co., Ltd. set at a cylinder temperature of 280° C. The thus-obtained specimens were evaluated according to the above-described measurement methods. The results of impact resistance and flame retardancy of molded products are shown in Table 1.

TABLE 1

| | | | Example | | | | |
|---|---|---|---|---|---|---|---|
| | | | 1 | 2 | 3 | 4 | 5 |
| Polyorgano- | Solvent | MeOH or | MeOH | MeOH | MeOH | MeOH | MeOH |
| siloxane- | washing | water amount | 500 | 1000 | 500 | 500 | 1000 |
| containing resin | condition | (g) | | | | | |
| | | Washing | 20 | 20 | 50 | 20 | 50 |
| | | temperature | | | | | |
| | | (° C.) | | | | | |
| | | Number of | 1 | 1 | 1 | 8 | 1 |
| | | times of | | | | | |
| | | washing | | | | | |
| | Volatile | After | 10 | 10 | 10 | 10 | 10 |
| | siloxane | dehydration | | | | | |
| | (%) | After solvent | 2.5 | 1 | 1 | 0.4 | 0.6 |
| | | washing | | | | | |
| | | After drying | 0.4 | 0.4 | 0.4 | 0.4 | 0.4 |
| | Ca(ppm) | After drying | 500 | 390 | 370 | 90 | 350 |

| | | | | | | |
|---|---|---|---|---|---|---|
| Polycarbonate- | Amount of resin mixed | 3 | 3 | 3 | 3 | 3 |
| based molded | (parts by weight) | | | | | |
| product | Flame retardancy | (V-2) | (V-2) | (V-2) | (V-2) | (V-2) |
| | Izod impact strength | 22 | 22 | 22 | 22 | 22 |
| | (KJ/m2) | | | | | |

| | | | Comparative Example | | |
|---|---|---|---|---|---|
| | | | 1 | 2 | 3 |
| Polyorgano- | Solvent | MeOH or | — | water | |
| siloxane- | washing | water amount | | 1000 | |
| containing resin | condition | (g) | | | |
| | | Washing | — | 50 | |
| | | temperature | | | |
| | | (° C.) | | | |
| | | Number of | — | 1 | |
| | | times of | | | |
| | | washing | | | |
| | Volatile | After | 10 | 10 | |
| | siloxane | dehydration | | | |
| | (%) | After solvent | — | | |
| | | washing | | | |
| | | After drying | 0.4 | 0.4 | |
| | Ca(ppm) | After drying | 4400 | 1300 | |

| | | | | |
|---|---|---|---|---|
| Polycarbonate- | Amount of resin mixed | 3 | 3 | 0 |
| based molded | (parts by weight) | | | |
| product | Flame retardancy | (V-2) | (V-2) | (Not-V) |
| | Izod impact strength | 20 | 20 | 14 |
| | (KJ/m2) | | | |

### Comparative Example 1

Synthesis, coagulation, heat treatment, drying powderization, mixing, molding, and evaluation were performed by the same methods as in Example 1 except that methanol washing and filtration were omitted. The results are shown in Table 1.

### Comparative Example 2

Synthesis, coagulation, heat treatment, drying powderization, mixing, molding, and evaluation were performed by the same methods as in Example 1 except that ion-exchanged water was used in place of methanol. The results are shown in Table 1.

### Comparative Example 3

Mixing, molding, and evaluation were performed by the same methods as in Example 1 except that a polyorganosiloxane-containing resin was not added in mixing with a polycarbonate resin. The results are shown in Table 1.

### INDUSTRIAL APPLICABILITY

Applications of molded products prepared from the resin composition of the present invention include, but are not limited to, applications requiring flame retardancy and impact resistance, such as a desktop computer, a notebook-size computer, a tower computer, a server computer, a printer, and a copying machine.

1. A process for producing a polyorganosiloxane-containing resin, comprising mixing a polyorganosiloxane-containing resin containing 5% by weight or more of volatile siloxane immediately after coagulation and dehydration with an organic solvent, and filtering the resultant mixture to decrease a residue in the resin.

2. The process for producing the polyorganosiloxane-containing resin according to claim 1, wherein the residue is a volatile siloxane.

3. The process for producing the polyorganosiloxane-containing resin according to claim 1, wherein the organic solvent is an alcohol.

4. The process for producing the polyorganosiloxane-containing resin according to claim 1, comprising mixing a polyorganosiloxane-containing resin after coagulation and dehydration with an organic solvent only once, and filtering the resultant mixture.

5. The process for producing the polyorganosiloxane-containing resin according to claim 1, wherein the Calcium content of the resin is 300 to 1,000 ppm.

6. A polyorganosiloxane-containing resin produced by the process according to any one of claims 1 to 5.

7. A resin composition comprising a thermoplastic resin and/or a thermosetting resin and the polyorganosiloxane-containing resin according to claim 6.
